(19) United States
(12) Patent Application Publication
(10) Pub. No.: US 2007/0005174 A1
(43) Pub. Date: Jan. 4, 2007

(54) VIRTUAL APPAREL FITTING

(75) Inventor: Gary D. Thomas, Cary, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: SONY ERICSSON MOBILE COMMUNICATIONS AB, Lund (SE)

(21) Appl. No.: 11/160,581

(22) Filed: Jun. 29, 2005

(51) Int. Cl. G06F 19/00

(52) U.S. Cl. 700/132

(57) ABSTRACT

A method, system and/or computer program product for virtual apparel fitting may include transmitting an identification code for an article of apparel to a virtual apparel fitting system. The method, system and/or computer program product may also include transmitting one of a 3-D body model, a 3-D body model identifier or a set of body measurements to the virtual apparel fitting system. The method, system and/or computer program product may further include presenting a virtual representation of the article of apparel applied to one of the 3-D body model, another 3-D body model corresponding to the 3-D body model identifier, or a further 3-D body model generable from the set of body measurements, wherein the virtual representation of the article of apparel applied to one of the 3-D body models is presentable in response to receiving the virtual representation from the virtual apparel fitting system.

### BACKGROUND OF THE INVENTION

The present invention relates to communications devices and systems, and more particularly to a communications device with a virtual apparel fitting feature and method for virtual apparel fitting.

Shopping for clothing can sometimes be an ordeal. Typically, an article of apparel must be located in the store and then carried to a fitting room for the individual to try-on the article. A proper sized mirror or array of mirrors must then be available or locatable for the individual to properly evaluate the fit and appearance of the article on the individual. This process can often take numerous iterations and expend a considerable period of time to arrive at a purchase decision which can lead to considerable wasted time and frustration on the part of the shopper. Similarly, shopping for clothing for children can also be time consuming and frustrating resulting in having to repeatedly change the child's clothing in order to find something that properly fits and has an appearance acceptable to the parent and possibly even to the child. There are also situations when an individual is shopping for another person who will actually be wearing the article of apparel. In these situations, determining an appropriate fit of apparel off a rack and other criteria important for a purchase decision may be difficult to determine without the person trying-on the article of apparel. This may result in the burden of having to return the apparel if the fit is improper or for some other reason, such as color, general appearance or the like, the apparel is inappropriate.

### BRIEF SUMMARY OF THE INVENTION

In accordance with an embodiment of the present invention, a method for virtual apparel fitting may include transmitting an identification code for an article of apparel to a virtual apparel fitting system. The method may also include transmitting one of a 3-D body model, a 3-D body model identifier or a set of body measurements to the virtual apparel fitting system. The method may further include presenting a virtual representation of the article of apparel applied to one of the 3-D body model, another 3-D body model corresponding to the 3-D body model identifier, or a further 3-D body model generable from the set of body measurements. The virtual representation of the article of apparel applied to one of the 3-D body models may be presentable in response to receiving the virtual representation from the virtual apparel fitting system.

In accordance with another embodiment of the present invention, a method for virtual apparel fitting may include applying a virtual representation of an article of apparel to one of a 3-D body model, another 3-D body model or a further 3-D body model in response to receiving an identification code corresponding to the article of apparel and one of the 3-D body model, a 3-D body model identifier or a set of body measurements. The 3-D body model identifier may correspond to the other 3-D body model and the further 3-D body model may be generable in response to receiving the set of body measurements.

In accordance with another embodiment of the present invention, a method for virtual apparel fitting may include applying a virtual representation of an article of apparel to one of a 3-D body model, another 3-D body model or a further 3-D body model in response to receiving an identification code corresponding to the article of apparel and one of the 3-D body model, a 3-D body model identifier or a set of body measurements. The processing and application of the virtual representation of an article of apparel to one of the aforementioned 3-D body models may be done entirely within a merchant's virtual apparel fitting system, partly within the merchant's virtual apparel fitting system and partly within a virtual apparel fitting system of a third party provider or entirely within a virtual apparel fitting system of a third party provider.

In accordance with another embodiment of the present invention, a system for virtual apparel fitting may include a transceiver adapted to receive an identification code corresponding to an article of apparel and to receive one of a 3-D body model, a 3-D body model identifier or a set of body measurements from a communications device. The system may also include a virtual apparel fitting feature operable on a processor and adapted to apply a virtual representation of the article of apparel based on the identification code for the article to one of the 3-D body model, another 3-D body model corresponding to the 3-D body model identifier or a further 3-D body model generable from the set of body measurements.

In accordance with another embodiment of the present invention, a system for virtual apparel fitting may include a transceiver adapted to receive an identification code corresponding to an article of apparel and to receive one of a 3-D body model, a 3-D body model identifier or a set of body measurements from a communications device. The system may also include a virtual apparel fitting feature operable on a processor and adapted to apply a virtual representation of the article of apparel based on the identification code for the article to one of the 3-D body model, another 3-D body model corresponding to the 3-D body model identifier or a further 3-D body model generable from the set of body measurements. The transceiver may be further adapted to display the virtual representation of the article of apparel applied to one of the 3-D body models on a display device, which is associated with a merchant's virtual apparel fitting system. The display device may be a computer monitor, TV monitor or the like and may be located in the vicinity of an article of clothing whose identification code was transmitted to the virtual apparel fitting system.

In accordance with another embodiment of the present invention, a communications device may include a device to enter an identification code for an article of apparel into the communications device. The communications device may also include a transmitter adapted to transmit an identification code for an article of apparel to a virtual apparel fitting system and to transmit one of a 3-D body model, a 3-D body model identifier or a set of body measurements to the virtual apparel fitting system.

In accordance with another embodiment of the present invention, a computer program product for virtual apparel fitting may include a computer readable medium having computer usable program code embodied therein. The computer readable medium may include computer usable program code configured to transmit an identification code for an article of apparel to a virtual apparel fitting system. The computer program product may also include computer usable program code configured to transmit one of a 3-D body model, a 3-D body model identifier or a set of body measurements to the virtual apparel fitting system. The computer program product may further include computer usable program code configured to present a virtual representation of the article of apparel applied to one of the 3-D body model, another 3-D body model corresponding to the 3-D body model identifier, or a further 3-D body model generable from the set of body measurements. The virtual representation of the article of apparel applied to one of the 3-D body models may be presented in response to receiving the virtual representation applied to one of the 3-D body models from the virtual apparel fitting system.

In accordance with another embodiment of the present invention, a computer program product for virtual apparel fitting may include a computer readable medium having computer usable program code embodied therein. The computer readable medium may include computer usable program code configured to apply a virtual representation of an article of apparel applied to one of a 3-D body model, another 3-D body model or a further 3-D body model in response to receiving an identification code corresponding to the article of apparel and one of the 3-D body model, a 3-D body model identifier or a set of body measurements. The 3-D body model identifier may correspond to the other 3-D body model and the further 3-D body model may be generable in response to receiving the set of body measurements.

Other aspects and features of the present invention, as defined solely by the claims, will become apparent to those ordinarily skilled in the art upon review of the following non-limited detailed description of the invention in conjunction with the accompanying figures.

### BRIEF DESCRIPTION OF THE SEVERAL VIEWS OF THE DRAWINGS

FIGS. 1A and 1B (collectively FIG. 1) are a flow chart of an example of a method for virtual apparel fitting in accordance with an embodiment of the present invention.

FIGS. 2A and 2B (collectively FIG. 2) are a flow chart of an example of a method for virtual apparel fitting in accordance with another embodiment of the present invention

FIGS. 3A and 3B (collectively FIG. 3) are a block schematic diagram of an exemplary system and communications device for virtual apparel fitting in accordance with another embodiment of the present invention.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalitalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

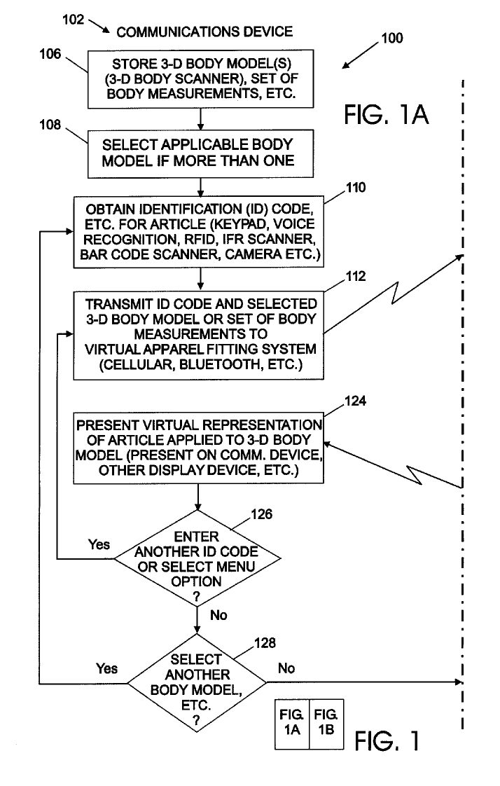

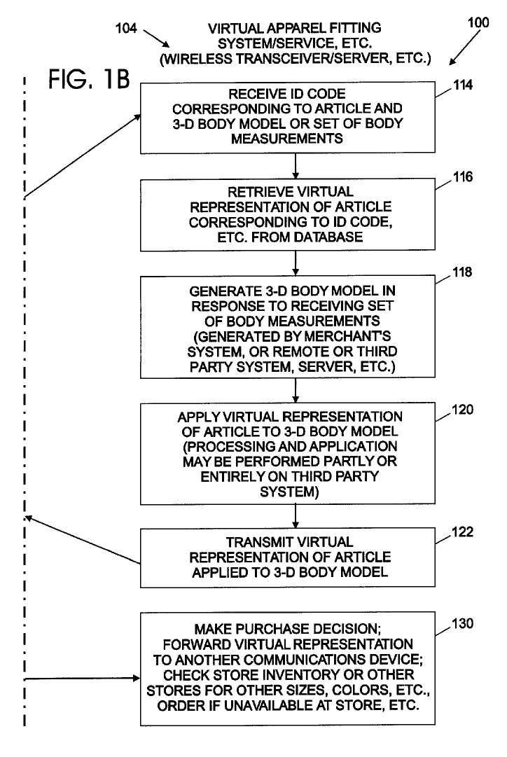

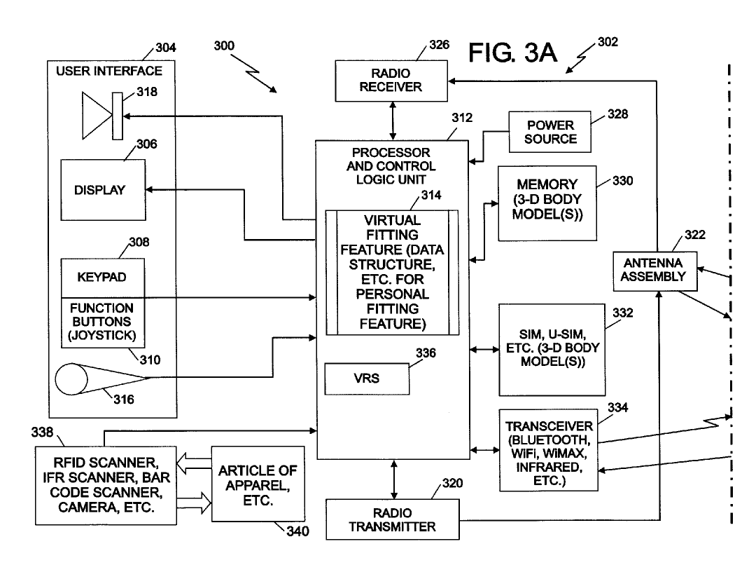

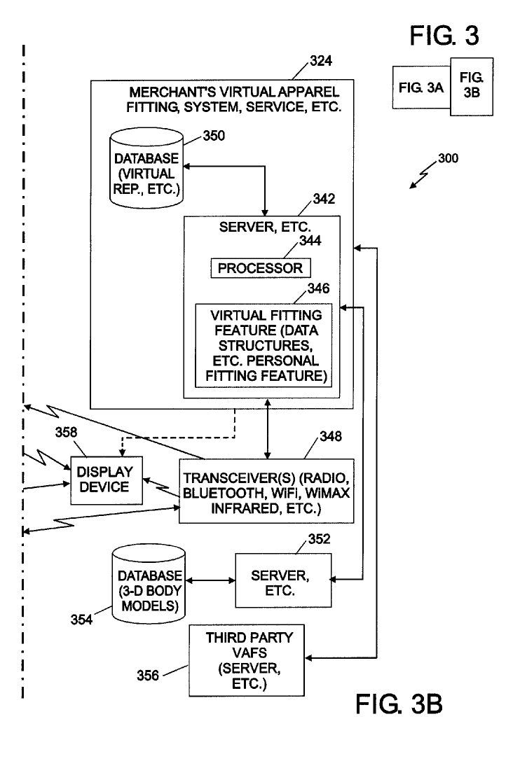

FIG. 1 is a flow chart of an example of a method 100 for virtual apparel fitting in accordance with an embodiment of the present invention. The flow chart in FIG. 1 is divided to illustrate functions or operations that may be performed by a communications device or devices 102 and functions or operations that may be performed by a virtual apparel fitting system 104, service or the like. The virtual apparel fitting system 104 may be a merchant's virtual fitting system or a third party provider's system. The functions and operations may be performed entirely within the merchant's system, partly within the merchant's system and partly within a third party provider's system, or entirely within the third party provider's system. The communications device may be a mobile, wireless communications device, such as a cellular telephone, personal digital assistant with a cellular telephone capability, communicator or similar device. As will be described in more detail herein with reference to FIG. 3, the virtual apparel fitting system may include a server, a wireless transceiver or similar components.

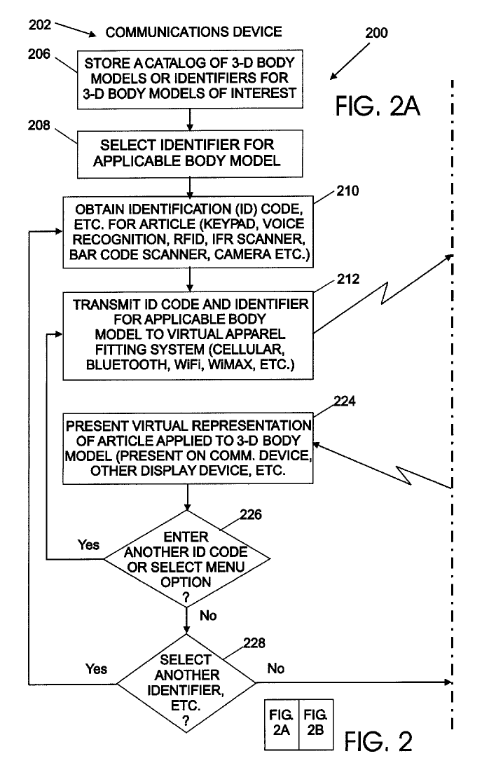

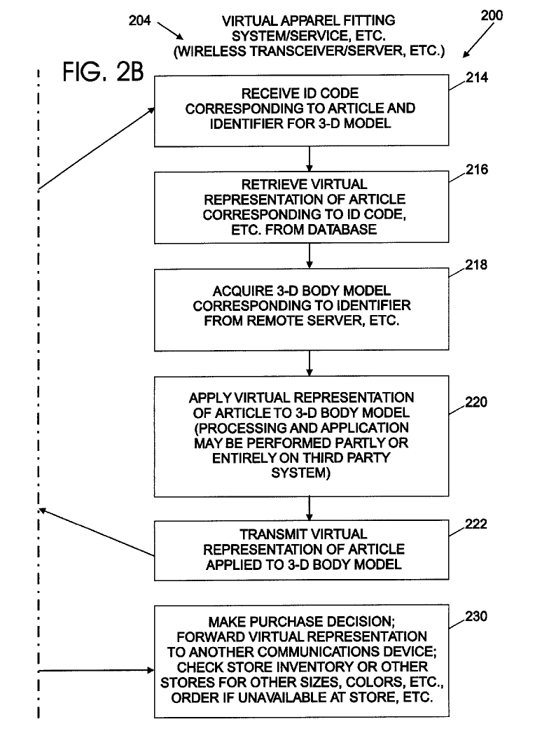

In block 106, a 3-D body model, a plurality of body models, a set of predetermined body measurements or a plurality of sets of predetermined body measurements or similar data may be stored in the communications device. The 3-D body model or models, set or sets of body measurements may be stored in a memory, Subscriber Identity Module (SIM), Universal SIM (U-SIM) or similar data storage feature in the communications device. In another embodiment of the present invention discussed in more detail with reference to FIG. 2, a catalog of 3-D body models or identifiers for 3-D body models of interest may be stored in the communications device. The actual 3-D body model of interest may then be retrieved from a remote or external database as described in more detail with reference to FIGS. 2 and 3 below. This embodiment may be utilized in situations where the data storage capacity of the communications device may be limited or the 3-D body model data is significant or for some other reasons storing the 3-D body models other than on the communications device is desirable.

The 3-D body model may be acquired by a 3-D body scanner, such as the 3-D Body Halo Scanner developed by the Pacific Northwest National Laboratory (PNNL) in Richland, Wash. Other body scanning systems for the clothing and fashion industry are described on the Apparel Search web site (www.apparelsearch.com) and “Comparative Analysis of the Image Twin System and the 3T6 Body Scanner”, Journal of Textile and Apparel, Technology and Management, Volume 1, Issue 2, Winter 2001.

In another embodiment of the present invention as indicated in block 106, predetermined body measurements may be taken, such as chest size, waist, arm length, width across shoulders, inseam and the like may be measured and stored. These predetermined body measurements may be used to generate a 3-D body model, as described herein; however, such a model may not be as precise or accurate and detailed as one derived from a 3-D body scanner.

In block 108, an applicable body model may be selected if more than one is available or stored in block 106. For example, a user may store 3-D body models or body measurements on the communications device for the user's children, spouse or others for whom the user may shop. The 3-D body model or set of body measurements may be selected by presenting the different representations or identifiers or the like on a display of the communications device. For example a menu may be presented with the names of the different people for whom 3-D body models or measurements are stored. The different names or other identifications may then be scrolled through using a function button or the like of the communications device, as described in more detail with respect to FIG. 3, to highlight or otherwise select the desired or appropriate 3-D body model or set of measurements of the person for whom the article of apparel may be intended.

In block 110, an identification (ID) code for a selected article of apparel may be obtained. The ID code may be a Universal Product Code (UPC), European Article Number (EAN) or similar identification number or code that may be printed on a tag, label or the like attached to the article of apparel or garment by a merchant or clothing manufacturer. The ID code may be obtained or entered by a keypad, infrared (IFR) scanner, bar code scanner, camera or the like associated with the communications device. In another embodiment of the present invention, the communications device may include a voice recognition system or feature and the user or shopper may simply read the ID code or number into the communications device. In a further embodiment of the present invention, the article of apparel may have a radio frequency identification (RFID) transponder attached and the communications device may include an RFID transceiver to interrogate the transponder and receive the ID code via RFID. RFID is being used today for security purposes to deter shoplifting, automated inventory control and other purposes and this could be another useful application.

In block 112, the ID code and the selected 3-D body model or set of body measurements may be transmitted to the virtual apparel fitting system or service. The ID code and 3-D body model may be transmitted by radio, such as cellular, Bluetooth, WiFi (Wireless Fidelity), WiMAX or similar wireless means. WiMAX is an air interface standard (IEEE 802.16) for fixed broadband wireless metropolitan access networks (MANs).

In block 114, the ID code corresponding to the article of apparel and the 3-D body model or set of body measurements may be received by the virtual apparel system or service. In block 116, a virtual representation of the article of apparel corresponding to the ID code may be retrieved. The virtual representation may be retrieved from a database or other data source that may be co-located with the virtual apparel fitting system or may be an external or remote database and the virtual representation may be retrieved or acquired via a network, such as the Internet, an intranet or other private network.

In block 118, a 3-D body model may be generated in response to a set of body measurements being received. The 3-D body model may be generated by a merchant's virtual apparel fitting system or a remote system or server or by a third party virtual apparel fitting system via a network. In block 120, the virtual representation of the article of apparel may be applied to the 3-D body model. As previously discussed, the processing and application of the virtual representation of the article of apparel to the 3-D body model may be performed entirely within a merchant's virtual apparel fitting system, partly within the merchant's apparel fitting system and partly within a virtual apparel fitting system of a third party provider, or entirely within the virtual apparel fitting system of the third party. In block 122, the virtual representation of the article of apparel applied to the 3-D body model may be transmitted to the requesting communications device.

In block 124, the virtual representation of the article of apparel applied to the 3-D body model may be presented to the user or shopper. The virtual representation applied to the 3-D body model may be presented by displaying on a display of the communications device. The virtual representation may need to be appropriately sized by the merchant's fitting system or by the communications device to properly fit the size of the display of the communications device. In another embodiment of the present invention, the virtual representation of the article of apparel applied to the 3-D body model may be presented on another display device, such as display associated with the merchant's virtual apparel fitting system. The other display device may be a computer monitor, television monitor or the like that may be located proximate to where the article of apparel is located in the store for the convenience of shoppers. The user or shopper may then visualize how the “off-the-rack” article of apparel may fit his or her exact body proportions or the body proportions of the person for whom the article of apparel may be intended. Thus, the user or shopper may visualize how the article of apparel may appear on them without actually having to try on the article.

In block 126, an ID code for another article of apparel may be entered. For example, the user or shopper may want to visualize what a different size, color or style may look like. In another embodiment, the user may be able to select one of these options or others from a menu that may be presented on the display of the communications device without having to enter another ID code. If a new ID code is entered or a menu option selected in block 126, the method 100 may then return to block 112 and the new ID code or menu option may be transmitted to the virtual apparel fitting system or service. The method 100 may then proceed similar to that previously describe with respect to blocks 114-124.

If a new ID code or menu option is not selected in block 126, the method 100 may advance to block 128. In block 128, another 3-D body model or set of body measurements may be selected. The method 100 may return to block 110 in response to selecting another 3-D body model or set of measurements in block 128. The method 100 may then proceed similar to that previously described.

If another 3-D body model or set of body measurements is not selected in block 128, the method may advance to block 130. In block 130, a purchase decision may be made. If the user or shopper decides to purchase the article of apparel, the user or shopper may actually try-on the article to confirm the fit and appearance.

Another option in block 130 may be to forward the representation to another communications device. For example, if the user or shopper is shopping for another, the virtual representation of the article applied to the 3-D body model may be sent to a communications device of the person for whom the article of apparel may be intended to permit that person to visualize his or her appearance in the article and the fit before making a purchase decision.

Another option in block 130 may be to permit a check of the store's inventory for other sizes, colors, styles or the like. Other sizes, colors, styles, etc. may be in a storeroom and not on the rack for whatever reason. The shopper may be able to determine this if permitted to access the store's inventory. This feature may also permit checking inventory at the merchant's other stores rather than requiring a clerk to call the other store. This feature of course requires that the store maintain accurate and up-to-date inventory records.

A further option in block 130 may be to permit the user or shopper to place an order for the article of apparel in a desired size, color, style or other available options, if not currently available off-the-rack at the store. The merchant may also permit ordering the article of apparel cut closer to the proportions of the 3-D body model. The order may be placed via the user's communications device equipped with the virtual fitting feature of the present invention.

FIG. 2 is a flow chart of an example of a method 200 for virtual apparel fitting in accordance with another embodiment of the present invention. Similar to method 100 of FIG. 1, the method 200 may be divided to illustrate functions or operations that may be performed by a communications device 202 and functions or operations that may be performed by a virtual apparel fitting system or service 204. The virtual apparel fitting system 204 may be a merchant's virtual fitting system or a virtual fitting system of a third party provider.

In block 206, a catalog of 3-D body models or identifiers for different 3-D body models of interest may be stored on the communications device. As previously discussed, the catalog of 3-D body models or identifiers may be stored in a memory of the communications device, SIM, U-SIM or the like associated with the communications device. A plurality of 3-D body model identifiers may be stored for different people for whom the user of the communications device may shop, such as children, a spouse and others. In block 208, an identifier for an applicable body model may be selected. The identifier may be selected by presenting the different identifiers on a display of the communications device. The different identifiers may then be scrolled through using a function button or the like on the communications device, as described in more detail with respect to FIG. 3, to highlight or otherwise select the desired or appropriate identifier for the 3-D body model of the person for whom the article of apparel may be intended.

In block 210, an identification (ID) code or the like may be obtained or entered for the article of apparel. Similar to that described with respect to block 110 of FIG. 1, the ID code, number or the like may be obtained or entered by a keypad, voice recognition, RFID, IFR scanner, bar code scanner, camera or the like.

In block 212, the ID code or number and the identifier for the applicable body model may be transmitted to the virtual apparel fitting system or service. The ID code and identifier may be transmitted by radio, such as Bluetooth or cellular, WiFi, WiMAX or similar transmission technology.

In block 214, the ID code corresponding to the article of apparel and the identifier for the 3-D body model may be received by the virtual apparel fitting system or service. As will be described in more detail with respect to FIG. 3, the virtual apparel fitting system or service may include a server and a wireless transceiver or the like.

In block 216, a virtual representation for the article of apparel corresponding to the ID code may be retrieved from a database or the like. The database may be remote from the virtual apparel system or service and the virtual representation of the article of apparel may be retrieved via a network, such as the Internet, intranet or other private network.

In block 218, a 3-D body model corresponding to the identifier may be acquired from a database, remote server or the like via a network. In block 220, the virtual representation of the article may be applied to the 3-D body model. As previously discussed, the processing and application of the virtual representation of the article of apparel to the 3-D body model may be performed entirely within a merchant's virtual apparel fitting system, partly within the merchant's apparel fitting system and partly within a virtual apparel fitting system of a third party provider, or entirely within the virtual apparel fitting system of the third party provider. In block 222, the virtual representation of the article of apparel applied to the 3-D body model may be transmitted to the requesting communications device.

In block 224, the virtual representation of the article of apparel applied to the 3-D body model may be presented on the communications device. The virtual representation applied to the body model may be presented on a display of the communications device. The virtual representation may need to be scaled by the communication device or the merchant's fitting system to fit the size of the display of the communications device. As previously discussed, the virtual representation of the article of apparel applied to the 3-D body model may be presented on another display device, such as display associated with the merchant's virtual apparel fitting system.

In block 226, another code may be entered or a menu option similar to that described with respect to block 126 in FIG. 1 for a different, size, color, style or the like of the article may be selected. If a new ID code is entered or menu option selected in block 226, the method 200 may return to block 212 and the method 200 may proceed similar to that previously described. If a new ID code is not entered or menu option selected, the method 200 may advance to block 228. In block 228, another identifier for a 3-D body model may be selected. The method 200 may return to block 210 in response to another body model being selected in block 228. The method 200 may advance to block 230 in response to another identifier not being selected in block 228.

In block 230, a number of different options may be available similar to that described with respect to block 130 in FIG. 1. For example, a purchase decision may be made. The virtual representation may be forwarded to another communications device, such as a communications device of the person for whom the article of apparel may be intended. The store's inventory or inventory of other stores may be checked for other sizes, colors, styles, or the like if unavailable at the store where the user is present. The user or shopper may be able to the use his or her communications device to order the article if unavailable or to order the article cut to more appropriately fit the selected 3-D body model.

FIG. 3 is a block schematic diagram of an exemplary system 300 and communications device 302 for virtual apparel fitting in accordance with an embodiment of the present invention. The communications device 302 may be a cordless telephone, cellular telephone, personal digital assistant (PDA), communicator, computer device or the like and is not unique to any particular communication standard, such as Advanced Mobile Phone Service (AMPS), Digital Advanced Mobile Phone Service (D-AMPS), Global System for Mobile Communications (GSM), Code Division Multiple Access (CDMA) or the like. The design of the communications device 302 illustrated in FIG. 3 is for purposes of explaining the present invention and the present invention is not limited to any particular design.

The communications device 302 may include an operator or user interface 304 to facilitate controlling operation of the communications device 302 including initiating and conducting phone calls and other communications. The user interface 304 may include a display 306 to provide visual signals to a subscriber or user as to the status and operation of the communications device 302. The display 306 may be a liquid crystal display (LCD) or the like capable of presenting color images. The display 306 may provide information to a user or operator in the form of images, text, numerals, characters, a graphical user interface (GUI) and the like. The display 306 may present a virtual representation of the article of apparel applied to the 3-D body model similar to that described with respect to blocks 124 and 224 of FIGS. 1 and 2 respectively. Different options or menus associated with the virtual fitting feature of the present invention may also be presented on display 306, such as identifiers for the different 3-D body models and options described with respect to blocks 126 and 130 of FIG. 1 and blocks 226 and 230 of FIG. 2.

The user interface 304 may also include a keypad 308 and function keys or buttons 310 including a point device, such as a joystick or the like. The keypad 308, function buttons and joystick 310 permit the user to communicate commands to the communications device 302 to dial phone numbers, initiate and terminate calls, establish other communications, such as access to the Internet, send and receive email, text messages and the like. The keypad 308, function buttons and joystick 310 may also be used to control other operations of the communications device 302. The keypad 308 and function buttons 310 may also be used to select an applicable 3-D body model or 3-D body model identifier and enter an ID code for an article of apparel as described with respect to methods 100 and 200 of FIGS. 1 and 2. The keypad 308 and function buttons 310 may further be used to select different options or menu items associated with the virtual fitting feature of the present invention, such as options described with respect to blocks 126 and 130 of FIG. 1 and blocks 226 and 230 of FIG. 2.

The display 306, keypad 308, and function buttons 310 may be coupled to a main processor and control logic unit 312. The main processor and control logic unit 312 may be a microprocessor or the like. The main processor and logic unit 312 may include a virtual fitting feature 314. The functions and operations 102 and 202 described with respect to a communications device in method 100 of FIG. 1 and method 200 of FIG. 2 may be embodied in the virtual fitting feature 314. The virtual fitting feature 314 may be embodied in hardware, firmware, software (data structures for virtual fitting) or combinations thereof. The main processor and logic unit 312 may also include other data structures, software programs, computer applications and the like to encode and decode control signals; perform communication procedures and other functions as described herein.

The user interface 304 may also include a microphone 316 and a speaker 318. The microphone 316 may receive audio or acoustic signals from a user or from another acoustic source. The microphone 316 may convert the audio or acoustic signals to electrical signals. The microphone 316 may be connected to the main processor and logic unit 312 wherein the main processor and logic unit 312 may convert the electrical signals to baseband communication signals. The main processor and control logic unit 312 may be connected to a radio transmitter 320 that may convert baseband signals from the main processor and control logic unit 312 to radio frequency (RF) signals. The radio transmitter 320 may be connected to an antenna assembly 322 for transmission of the RF signals to a communication medium or system, such as a merchant's virtual apparel fitting system, service or the like 324.

The antenna assembly 322 may receive RF signals over the air and transfer the RF signals to a radio receiver 326. The radio receiver 326 may convert the RF signals to baseband signals. The baseband signals may be applied to the main processor and control logic unit 312 which may convert the baseband signals to electrical signals. The processor and control unit 312 may send the electrical signals to the speaker 318 which may convert the electrical signals to audio signals that can be understood by the user.

A power source 328 may be connected to the main processor and control logic unit 312 to provide power for operation of the communications device 302. The power source 328 may be a rechargeable battery or the like. The communications device 302 may also include at least one data storage device or memory 330. The memory 330 may be a computer-readable medium to store computer-executable or computer-usable instructions or data structures, such as the data structures to perform special operations or functions such as those described in accordance with embodiments of the present invention. The memory 330 may store the 3-D body models or a catalog or identifiers of 3-D body models, if data storage capacity is limited or the data for the actual 3-D body models are stored elsewhere for some reason.

In another embodiment of the present invention, the communications device 302 may also include a subscriber identity module (SIM) 332, a universal SIM (U-SIM) or the like to store a user's personal preferences and other subscriber information. The 3-D body models or catalog of identifiers of 3-D body models may be stored on the SIM or U-SIM.

The communications device 302 may also include a transceiver 334 for short range communication with other devices and systems, such as the merchant's virtual apparel fitting system or service 324 or the like. The transceiver 334 may be a Bluetooth, WiFi, WiMAX, infrared or other technology short range transceiver. The transceiver 334 may be used for transmitting 3-D body models, 3-D body model identifiers or body measurements and ID codes for articles of apparel to the merchant's virtual apparel fitting system or service, similar to that described with respect to the methods 100 and 200 of FIGS. 1 and 2. The transceiver 334 may also receive a virtual representation of an article of apparel applied to a 3-D model, as transmitted from a merchant's virtual apparel fitting system, similar to that described with respect to the methods 100 and 200 of FIGS. 1 and 2.

The communications device 302 may also include a voice recognition system (VRS) 336 or function. The voice recognition system 336 may be embodied in hardware, software, firmware, a combination thereof or the like and may operate in association with the processor and control logic unit 312. The voice recognition system 336 may be coupled to the microphone 316 to permit a user or operator to control operation of the communications device 302 by voice commands to establish communications or perform other operations or functions, such as those associated with the virtual fitting feature 314 of the present invention.

The communications device 302 may also include a device or scanner 338, such as an RFID scanner, IFR scanner, bar code scanner or the like or a camera to obtain or enter an ID code for an article of apparel 340, clothing or the like. As previously disclosed the ID code may be on a tag, label or the like associated with the article of apparel or transmitted by an RFID transponder in response to interrogation from an RFID scanner.

The merchant's virtual apparel fitting system or service 324 may include a server 342. The server 342 may include a processor 344 to control operation of the server 342 and its associated components. The server 342 may also include a virtual fitting feature 346 that may be operable on the processor 344. The functions and operations 104 and 204 described with respect to methods 100 and 200 of FIGS. 1 and 2 may be embodied in the virtual fitting feature 346. The virtual fitting feature 346 may be embodied in hardware, firmware, software (data structures for virtual fitting) or combinations thereof.

The virtual apparel system or service 324 may also include or have associated therewith a transceiver 348. The transceiver 348 may be a Bluetooth, infrared, WiFi, WiMAX or other type short range transceiver. The transceiver 348 may also be a radio transceiver adapted to communicate with the radio receiver 326 and radio transmitter 320 through antenna system 322 of the communications device 302. The transceiver 348 may receive 3-D body models, 3-D body model identifiers or body measurements and ID codes for articles of apparel and transmit virtual representations of articles of apparel applied to 3-D body models similar to that described with respect to methods 100 and 200 of FIGS. 1 and 2.

The merchant's virtual apparel fitting system or service 324 may also include a database 350 to store virtual representations of the articles of apparel corresponding to the ID codes. The database 350 may be part of the virtual apparel system 324 or may be a separate entity at a remote location from the system 324 and may be accessible via a network, such as the Internet, intranet or other private network.

The system 300 may also include another server 352 and a database 354. The database 354 may include 3-D body models corresponding to identifiers that may be sent to the merchant's virtual fitting system 324 as described in method 200 of FIG. 2. The server 352 may facilitate management and access to the database 354.

In another embodiment of the present invention, the system 300 may include a third party virtual apparel fitting system (VAFS) 356. As previously discussed, the processing and application of a virtual representation of an article of apparel to a 3-D body model may be performed entirely within the merchant's virtual apparel fitting system, or partly within the merchant's virtual apparel fitting system and partly within the virtual apparel fitting system of a third party provider, or entirely within a virtual fitting system of a third party provider. In the later embodiment, the merchant may not have a virtual apparel fitting system or service but may rather have this service available through the third party system 356. The third party system 356 may transmit the results back to the merchant's system 324 for transmission to the communications device 302 or the third party system 356 may transmit the results directly to the communications device 302.

The system 300 may also include a display device 358 that may be associated with the merchant's virtual apparel fitting system 324 to display the virtual representation of the article of apparel applied to a 3-D body model. The display device 358 may be a computer monitor, television monitor or like and may be located proximate to an article of apparel in the store whose identification code may be transmitted to the merchant's virtual apparel fitting system 324. The display device 358 may receive data signals from the merchant's virtual apparel fitting system 324, the communications device 302 or the transceiver 348 associated with the merchant's virtual apparel fitting system 324 to display the virtual representation applied to the 3-D body model. In one embodiment of the present invention, the display device 358 may also receive data signals directly from the third party virtual apparel fitting system 356 to display the virtual representation of the article of clothing applied to the 3-D body model, if a third party is providing the service.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

1. A method for virtual apparel fitting, comprising:
allowing transmission of an identification code for an article of apparel from a mobile wireless communications device directly to a virtual apparel fitting system;
allowing transmission of one of a 3-D body model, a 3-D body model identifier or a set of body measurements from the communications device directly to the virtual apparel fitting system; and
presenting a virtual representation of the article of apparel applied to one of the 3-D body model, another 3-D body model corresponding to the 3-D body model identifier, or a further 3-D body model generable from the set of body measurements, wherein the virtual representation of the article of apparel applied to one of the 3-D body models is presentable in response to receiving the virtual representation from the virtual apparel fitting system.

2. The method of claim 1, further comprising allowing storage of at least one of the 3-D body model, the 3-D body model identifier or the set of body measurements in the mobile wireless communications device for transmission directly to the virtual apparel fitting system.

3. The method of claim 1, further comprising allowing storage of a plurality of 3-D body models, a plurality of 3-D body model identifiers or a plurality of sets of body measurements on the communications device, each 3-D body model, 3-D body model identifier or set of body measurements corresponding to a different individual for selection for transmission to the virtual apparel fitting system.

4. The method of claim 1, further comprising allowing entry of the identification code for the article of apparel into the communications device.

5. The method of claim 4, wherein allowing entry of the identification code for the article of apparel comprises allowing entry by one of a group comprising a keypad, voice recognition, RFID, IFR scanning, bar code scanning or a camera.

6. The method of claim 1, wherein allowing transmission of the identification code for the article and allowing transmission of one of the 3-D body model, 3-D body model identifier, or the set of body measurements comprises allowing transmission by one of a group comprising a radio, Bluetooth, WiFi, WiMAX or infrared transceiver.

7. The method of claim 1, wherein presenting the virtual representation of the article of apparel applied to one of the 3-D body models comprises presentation on a display of the communications device.

8. The method of claim 1, further comprising acquiring the other 3-D body model corresponding to the 3-D body model identifier from one of a database or a remote system.

9. The method of claim 1, further comprising checking a merchant's inventory for other articles corresponding to the article of apparel.

10. A system for performing the method of claim 1.

11. A computer-readable medium having computer-executable instructions for performing the method of claim 1.

12. A method for virtual apparel fitting, comprising applying a virtual representation of an article of apparel to one of a 3-D body model, another 3-D body model or a further 3-D body model in response to receiving an identification code corresponding to the article of apparel and one of the 3-D body model, a 3-D body model identifier or a set of body measurements directly from a mobile wireless communications device, wherein the 3-D body model identifier corresponds to the other 3-D body model and the further 3-D body model is generable in response to receiving the set of body measurements.

13. The method of claim 12, further comprising transmitting the virtual representation of the article of apparel applied to one of the 3-D body models to the communications device.

14. The method of claim 12, further comprising receiving the identification code of the article of apparel and one of the 3-D body model, 3-D body model identifier or set of body measurements at a virtual apparel fitting system, wherein receiving is by one of a group comprising a radio, Bluetooth, WiFi, WiMax or infrared transceiver.

15. The method of claim 12, further comprising allowing entry of the identification code of the article of apparel by one of a group comprising a keypad, voice recognition, RFID, IFR scanning, bar code scanning or a camera.

16. The method of claim 12, further comprising acquiring the other 3-D body model corresponding to the 3-D body model identifier from one of a database or a remote system.

17. A system for virtual apparel fitting, comprising:
a transceiver adapted to receive an identification code corresponding to an article of apparel and to receive one of a 3-D body model, a 3-D body model identifier or a set of body measurements directly from a mobile wireless communications device; and
a virtual apparel fitting feature operable on a processor and adapted to apply a virtual representation of the article of apparel based on the identification code for the article to one of the 3-D body model, another 3-D body model corresponding to the 3-D body model identifier or a further 3-D body model generable from the set of body measurements.

18. The system of claim 17, further comprising a database to store a plurality of virtual representations of articles of apparel.

19. The system of claim 17, further comprising means to generate a corresponding 3-D body model based on the set of body measurements in response to the set of body measurements being received.

20. The system of claim 17, wherein the transceiver comprises one of a radio transceiver, a Bluetooth transceiver, a WiFi transceiver, a WiMAX transceiver, or an infrared transceiver.

21. The system of claim 17, further comprising one of a database or a remote system or server for acquiring the other 3-D body model in response to the 3-D body model identifier being received.

22. The system of claim 17, further comprising a display device to present the virtual representation of the article applied to one of the 3-D body models.

23. A mobile wireless communications device, comprising:
a device to enter an identification code for an article of apparel into the mobile wireless communications device; and
a transmitter adapted to transmit the identification code for the article of apparel directly to a virtual apparel fitting system and to transmit one of a 3-D body model, a 3-D body model identifier or a set of body measurements directly to the virtual apparel fitting system from the mobile wireless communications device.

24. The communications device of claim 23, further comprising a display to present a virtual representation of the article of apparel applied to one of the 3-D body model, another 3-D body model or a further 3-D body model in response to receiving the virtual representation of the article of apparel applied to one of the 3-D body models from the virtual apparel fitting system, wherein the other 3-D body model corresponds to the 3-D body model identifier and the further 3-D body model is generable from the set of body measurements.

25. The communications device of claim 23, further comprising means to store at least one 3-D body model, at least one 3-D body model identifier or at least one set of body measurements.

26. The communications device of claim 23, further comprising means to convert the set of body measurements to a corresponding 3-D body model.

27. The communications device of claim 23, further comprising one of a radio transceiver, a Bluetooth transceiver, a WiFi transceiver or a WiMAX transceiver to transmit the identification code for the article of apparel and one of the 3-D body model, 3-D body model identifier or set of body measurements.

28. A computer program product for virtual apparel fitting, the computer program product comprising:
a computer readable medium having computer usable program code embodied therein, the computer readable medium comprising:
computer usable program code configured to transmit an identification code for an article of apparel from a mobile wireless communications device directly to a virtual apparel fitting system;
computer usable program code configured to transmit one of a 3-D body model, a 3-D body model identifier or a set of body measurements directly to the virtual apparel fitting system; and
computer usable program code configured to present a virtual representation of the article of apparel applied to one of the 3-D body model, another 3-D body model corresponding to the 3-D body model identifier, or a further 3-D body model generable from the set of body measurements, wherein the virtual representation of the article of apparel applied to one of the 3-D body models is presentable in response to receiving the virtual representation applied to one of the 3-D body models from the virtual apparel fitting system.

29. The computer program product of claim 28, further comprising computer usable program code configured to acquire the identification code for the article of apparel.

30. The computer program product of claim 28, further comprising computer usable program code configured to store at least one of the 3-D body model, the 3-D body model identifier or the set of body measurements in the mobile wireless communications device for transmission directly to the virtual apparel fitting system.

31. The computer program product of claim 28, further comprising computer usable program code configured to generate the further 3-D body model from the set of body measurements.

32. A computer program product for virtual apparel fitting, the computer program product comprising:
a computer readable medium having computer usable program code embodied therein, the computer readable medium comprising:
computer usable program code configured to apply a virtual representation of an article of apparel applied to one of a 3-D body model, another 3-D body model or a further 3-D body model in response to receiving an identification code corresponding to the article of apparel and one of the 3-D body model, a 3-D body model identifier or a set of body measurements directly from a mobile wireless communications device, wherein the 3-D body model identifier corresponds to the other 3-D body model and the further 3-D body model is generable in response to receiving the set of body measurements.

33. The computer program product of claim 32, further comprising computer usable program code configured to transmit the virtual representation of the article of apparel applied to one of the 3-D body models to the communications device.

34. The computer program product of claim 32, further comprising computer usable program code configured to receive the identification code of the article of apparel and one of the 3-D body model, 3-D body model identifier or set of body measurements by one of a group comprising a radio, Bluetooth, WiFi, WiMax or infrared transceiver.

35. The computer program product of claim 32, further comprising computer usable program code configured to allow entry of the identification code of the article of apparel by one of a group comprising a keypad, voice recognition, RFID, IFR scanning, bar code scanning or a camera.
